(19) United States
(12) Patent Application Publication
(10) Pub. No.: US 2026/0216563 A1
(43) Pub. Date: Jul. 30, 2026

(54) SPORTS GAME WITH ASSOCIATED CHARACTERS

(71) Applicant: Andon Technology Pty Ltd, Queensland (AU)

(72) Inventor: Joe Andon, Wakerley (AU)

(21) Appl. No.: 19/150,851

(22) PCT Filed: Jan. 25, 2024
(86) PCT No.: PCT/AU2024/050046

§ 371 Date: Jul. 24, 2025

(30) Foreign Application Priority Data
Jan. 27, 2023 (AU) 2023900191

(51) Int. Cl. A63B 24/00; A63B 43/06; A63B 67/00; A63B 71/06; A63F 13/5375; A63F 13/825

(52) U.S. Cl. CPC A63B 24/0059; A63B 24/0021; A63B 43/06; A63B 67/002; A63B 71/0622; A63F 13/5375; A63F 13/825; A63B 2071/0625; A63B 2071/0694; A63B 2243/00; A63F 2300/8011

(57) ABSTRACT

A system of enhancing a sports game is described. The system comprises a first item assigned to a first player and a second item assigned to a second player. The first player and the second player move with their item in the game according to predetermined rules. There is an electronic character associated with each item. The electronic character can visually incrementally increase or decrease in strength and/or status as points are accrued in the game or when a win or loss is recorded in the game.

### TECHNICAL FIELD

The present invention involves enhancing the gaming experience within a sports game through the application of gamification principles. In an embodiment, the invention relation to a ball game in which a character associated with the ball changes according to its status in the game.

### BACKGROUND

Conventional ball games involve players passing a ball amongst themselves, usually with a view to scoring points. In soccer, a football is passed between players in a team, usually by kicking the ball between team members, with the aim being to get the ball into a goal. Some ball games involve throwing balls into a net to score points/goals (e.g. netball or basketball). Other ball games involve sticks, rackets, or other implements to propel the ball towards a target. Ball games are usually fun and enjoyable, because they build physical and mental skills, improve team building, and get people outside socialising with others. Most children enjoy ball games, and it is not unusual for them to practice them in organised venues including at schools and social clubs. Ball games can also be casually enjoyed in parks and gardens.

Sometimes, where balls are not available, children will create games that are similar to ball games, but that do not involve a ball. One game that children play is called Tag (sometimes called tig or “it”). Tag is a playground game involving two or more players. A nominated player chases other players in an attempt to “tag” and mark them out of play, usually by touching with a hand. There are many variation of the game which are mostly informal and have no team structure, scores, or equipment.

Outdoor games used to be an extremely popular arena for children. In order to occupy themselves, children would leave the house and go outside to play ball games, playground games and sometimes to play at a park. Today, children tend to be more familiar with indoor technology-based play. Even from a very young age children are able to manipulate technology to watch shows and play “video” games. Electronic devices are now becoming more prevalent in schools. However, it is not unusual for a child to have their own electronic device even prior to attending school.

Children enjoy playing on electronic devices in fantasy worlds. Games like Minecraft and Roblox that involve networks of children creating electronic fantasy “worlds” are increasingly popular. A concern with these computerised games is that they are addictive and by their screen-based nature are typically used inside and with little to no movement. It is not uncommon for parents to set rules and time limits for “screen-based play” sometimes with rewards given for outdoor play. It can be extremely difficult to get children to stop playing computers games. Encouragement and motivation is typically requires to get children outside and moving.

A combination of outside activity with technology was introduced by Nintendo with the Pokémon Go platform. A player (including a child) can create an avatar that moves around in the real world. When a player finds a Pokémon it can be viewed either within Augmented Reality (AR) mode, or with a live rendered background. The Pokémon Go platform is credited with popularising location-based and AR technology, promoting physical activity, and helping local businesses grow due to increased foot traffic. However, its use became regulated in some countries due to its players encroaching into sensitive areas such as cemeteries and railway tracks.

In modern times, with computer technology being pervasive, anything that keeps children occupied outside and that gets children active is popular and desirable with parents and caregivers. If the outside activity is coupled with technology, this will likely assist in engaging and motivating the child and is likely to make the proposed activity more usable and sustainable.

### SUMMARY OF INVENTION

In a first aspect of the present invention, there is provided a system of enhancing a sports game, the system comprising:
a first item assigned to a first player;
a second item assigned to a second player;
wherein the first player and the second player move with their item in the game according to predetermined rules;
the first item and the second item being in electronic communication with one another and configured to be usable together in the game;
wherein during the game the first player with the first item interacts with the second player with the second item, the rules of the game including scoring of points and/or assignment of a winner and a loser status to each of the first player and the second player, respectively, according to said rules;
an electronic character associated with each item, wherein the electronic character is a computer graphic optionally displayed by the item, wherein the electronic character is changeable visually according to points scored in the game and/or the winner status or loser status in the game;
wherein the electronic character can visually incrementally increase in strength and/or status as points are accrued in the game or when a win is recorded in the game, and wherein the electronic character can visually incrementally decrease in strength and/or status as points are lost in the game or when a loss is recorded by that electronic character in the game.

The present invention combines an outdoor game activity with technology. By combining the child's enjoyment of technology with something like a sports game, the child is much more likely to want to try the game and to remain involved with it once played.

In the game, the item is assigned to the player so that the physical actions that the player takes has an effect on what happens to the item. The item can be any object that can be associated with the player. The item is transported by the player, so the item is a transportable item. As the player moves, the item moves with them. The item can be attached to the player. The item can be carried by the player. The item can be worn by the player. The item can be held in the player's hand. In an embodiment, the item is a wrist band attached around the player's wrist. In an embodiment, the item is a ball or other carryable object held in the players hand or otherwise carried about their person. The ball can be attached to a lanyard that could be worn around the neck.

Thus, in one aspect there is provided a ball intended for use by a player in a multiple player game;
the ball configured to communicate electronically with another ball and configured so as to be usable together with that other ball in a game with rules, the rules allowing for the scoring of points in the game and or for the assignment of a winner and a loser status to the player having the ball in the game;
a character associated with each ball, wherein the character is a computer graphic displayed by the ball, wherein the character is changeable visually according to points scored in the game and/or the winner status or loser status of the player in the game.

Also described is a plurality of items when sold in a set together with rules for how to play the game with the balls. Since multiple items will be required to be used in a game, with multiple players, the rules can set out how each player can play. The items can also be sold separately if a player wants to have a special item that is tailored to their own aesthetic. The rules can be provided electronically. The invention also provides a game played using the plurality of items. The game has rules as described herein.

When the item is a ball, the ball can be sized so as to comfortably fit into a player's hand. The ball can be designed to be ergonomic so it can be gripped tightly even when the player is running. The ball can be at most about 8, 10, 12 cm in diameter, however it could be larger or smaller according to design specifications. The ball can be rigid. The outside of the ball can be formed from a solid and strong material. The ball can have soft rubberised parts that allow it to be squeezable and therefore gripped more tightly. The ball can be aesthetically pleasing and may be decorated with one or more of colours, shapes, lights and other decals.

The ball is powered and comprises electronics. The ball (or other item) can be configured to switch off electronically when not being held. This can help to discourage the ball being thrown at other players in the game. The items in the game are not intended to be used as projectiles.

There should be at least two players in order to play the game to achieve a result. This is because each item, such as a ball, has to communicate with another item in order for points to be scored, or for there to be a winner and a loser assigned to each participant. However, as with all games, it is possible to play alone with an outcome to the single-player game that is a variation on the multiple player game. In embodiments, the player might be set a task when playing alone that they need to achieve to score points. The player might have to move a certain distance or in a certain direction in order to score points. The movement can be by walking, running, cycling, scooting. Preferably, the tasks are those that keep the player active, so they involve at least some sort of physical movement and activity. The item might have a means for interfacing it to a computer, so that more single-player options can be programmed into the ball.

When the game is played with multiple players, there can be any number of players. If there are many players (e.g. more than 10), the game can be more fun since there will be various characters associated with the items and variations in skill levels to explore and investigate. When starting the game, the players A, B, C, D, etc, may all need to be close to one another (within a few meters) to allow each item to electronically link with each other item in the close network.

The items can communicate with one another by any electronic means including radio waves, mobile network, Bluetooth, through Wi-Fi, or other.

An underlying premise of the game is that a first player (e.g. Player A) having a first item interacts with a second player (e.g. Player B) having a second item. The interaction can be any that causes the players to move towards and away from one another. In an embodiment, a first player (e.g. Player A) is chased by a second player (e.g. Player B). If the second player is “caught” (e.g. tagged by the hand) then the second player can score points and/or be recorded as the winner. The first player may lose points or be recorded by the item as the loser. The items will be aware of the close proximity that requires the points change or winner/loser status to be recorded. For example, as the second player moves closer to the first player, the items move into electronic communication range with one another and are able to transfer information as to their respective statuses. Another form of interaction might be where the first player hides and a second player seeks them. The items can interact to provide clues as to where one player is hiding. For example, the first item hidden with the first player might beep and the beeping may get louder as time passes. The seekers item might change (noise, colour, vibration) as they move closer to the hidden player. With a time limit set for finding the hidden player, if the player is found then points or a winning status can be assigned to the seeker and a loser status to the hider. If the hidden player is not found, on the other hand, then they are the winner (or score points). The actual game is not the subject of the invention. Any game where points can be distributed and or a winner or loser can be assigned by a pair of electronically interacting items can be imagined.

While at least a pair of items is required for the assignment of points or winner/loser status, there can be multiple paired items in the game. In a game with a plurality of items, each item when it communicates with another item can become a part of the “pair”. In which case, an item can pair with more than one other item in any one game.

Each item is able to communicate visually, physically or audibly with its assigned player. The communication can be through sound, colour or other means such as vibration. In embodiments in which there is chasing, in order that the item is able to register whether it is the chasing player (second player) or the chased player (first player) the item can be assigned a mode that is communicated to the user. When the player is the chaser, the item might have green light(s), it might vibrate and/or make a noise (chasing mode (sometimes referred to as predator mode)). The light(s) may be flashing. The vibration can be intermittent. The noise can be beeping or other sounds as appropriate. When the player is vulnerable to being chased, it might have red light(s), it might stop vibrating and make no noise at all (stealth mode (sometimes referred to as prey mode)).

The items might respond to one another as they get closer to one another. For example, prey mode might be switched to alarm mode (lock-on mode) if a chasing player gets close. The alarm mode might cause the item to change to a third colour (e.g. blue) and cause the chasing player to realise that there is a player close by that is eligible to be caught. The default lock on time might be at least 3, 2 or 1 seconds. It might take longer to lock onto a highly ranked player. It might take longer to lock onto certain other players according to their characteristics. This lock on mode could be extremely fun and cause the players to be delighted when the lock on is activated and they will run about in all directions.

In some embodiments, the respective chasing mode and stealth modes last for about 30, 40, 50, 60 or more seconds and then switch between players or groups of players. By switch it is meant that the first player who was being chased changes/switches to become the chaser. The player must remain alert at all times as to their mode, so they know how to follow the rules to gain points or win. A first chase mode might be longer than subsequent chase modes.

In embodiments, the more points or increased status of a player in the game, the longer is their chasing mode. The chasing mode might start at 60 seconds but increase in 5 or 10 (or more) second increments as status or rank is increased. A high-ranking player might have a chasing time of 90 to 120 (or more) seconds. There may also be bonuses available in the game to increase chasing time. For example, there might be a bonus of 10 or 15 (or more) seconds for catching 2 players in the allotted chasing time. There might be a bonus of 10 or 15 (or more) seconds for running for the entire span of the allotted time.

Furthermore, the mode in which the player is being chased might start at 60 seconds but decrease in 5 or 10 (or more) second increments as status or rank is increased. A high-ranking player might have a time being chased of 45 to 30 (or less) seconds. There may also be bonuses available in the game to decrease the time the player is being chased. For example, there might be a bonus of 5 or 10 (or less) seconds awarded as the chase for catching 2 players in the allotted chasing time. There might be a bonus of 5 or 10 (or less) seconds awarded for running for the entire span of the allotted chasing time. There could also be a bonus awarded for running the entire span of the time spent being chased, with the bonus being again a deduction in the length of the time the player spends as the chase. The variations in the rules and the time spans are endless and can be pre-determined by the software programmed into the item.

These rules are pre-determined by the software in the electronics of the item. The item has programmable software that provides an ability to control who is chasing, enforce rules and accumulate results over time. The games rules can change from time to time by downloading a variation of the rules from a central hub. The games can be downloaded with rules pre-determined by a third party. Alternatively, the players can create their own rules which might suit their own abilities and or terrain. The players can read about the rules prior to playing the game, or they might become aware of the rules through trial and error as they play the game.

Once defeated, the loser of a chasing battle might need some time out. This can be referred to as healing mode. In healing mode, the item might display a certain colour (e.g. yellow) and the player can watch the others play and encourage the others by helping them to identify their modes or to find players that are hiding. The higher the ranking of the character and player, the shorter the healing mode may be. The amount of damage caused by another player might depend on that players character type of on their ranking.

Characters can be grouped according to characteristics. Each character might have certain characteristics that they are given and cannot be changed. The characters might be assigned a gender. The characters might be assigned an element such as fire, earth, water. These characteristics are variable according to the various embodiments and design.

The item can have one or a plurality of LED lights visible on its surface. The LED lights can display the various modes as outlined above. There can be any number of LED lights across the surface. In an embodiment, the LED lights are in strips around a periphery of a balls surface.

The item can have one or more inbuilt speakers that play sounds. The sounds can be blips, beeps, animal noises, alarms, songs. There can be victory songs when the player is the winner. There can be loser songs that invoke a feeling of sadness (but keep trying!).

The item can have one or more inbuilt means for effecting vibration. The vibrators can complement one or more of the lights and sound effects. Other sensory characteristics could be assigned to the ball such as smells or textures in the materials used to make the balls.

Each item has a character associated with it. The character can be selected from a set. The set can be a set of popular characters. Alternatively, each character can be unique. The unique character could be an avatar of the player. The character can be displayed as a computer graphic by the item. The display of the character can be on the outside of the item. There can be a screen on the outside of the item that is visible to the player. In some embodiments, the display of the character can be on the inside on the item. When the character is on the inside of the item, the user has to peer into the item to see the character. This has the advantage of making the character feel like it is owned and controlled by the player, but that it lives in its own world. The player peering in to view the character might feel omnipotent and powerful, peering in to see how their physical movement in the outside world is affecting some other being living in a seemingly parallel universe.

The character can have various modes. The modes can complement the modes of the player including chasing mode, chased mode, healing mode. The character can also have some fun and pleasing modes that entertain the user when they peer into the item. The modes can include eating, sleeping, emotional (including happy, grumpy, angry), defecating, etc. The character can make funny noises such as burps and farts. In embodiments, when the item is not in use in the game, the item can vibrate, make noise and or flash lights according to the characters moods/actions.

The character can be a hologram inside the item. A holographic character is particularly appealing because it adds weight to the notion that the character is real and influenced by the player. In order to effect the hologram, there can be an LED screen inside the item which is programmable by a motherboard. The hologram can seem to move in 3-dimensions.

In locations where it is desirable that screens are not used, e.g. schools, the character may be displayed separately to the item. The item can electronically communicate the information about the characters status to an electronic device, and the character can then be viewed on a screen such as a mobile phone, smart phone or other device. The item can transmit the information in real time. Alternatively, the item can store the information for later uploading to the electronic device (e.g. after school). An application (app) can be used on the electronic device to display the character and its information.

The character can be changeable visually according to points scored in the game and/or the winner status or loser status in the game. For example, as points are scored, or as wins are accrued, the character can grow from a baby of the character to an adult of the character. The change in the character can be incremental. The character can seem to grow as the player progresses in the game. The character could get stronger as visually indicated by larger muscles or better clothes or some other coloured/aesthetic changes. Skins can be obtained for the character to change its overall aesthetic and the aesthetic of the environment in which it is situated.

If the game rules comprise a point system, then the embodiment of the item can include those points displayed alongside the character. The points can be increasable by winning, and decreasable by losing in the game. There can be other information displayed alongside the points including time, stop watch, calories burned, steps taken, time spent off screens. There can be a ranking for the character (and by proxy for the player). This ranking can be local or global.

The item can interface with a computer to allow data to be downloaded about past activity including past battles and past activities. The data can also be interfaced into a virtual world in which the character could start to take on a new life and play chase electronically. The transition from real outside world to virtual world is something that might attract young children and encourage them to play with the item. The main focus of the present item however is to keep children moving, so the outside chase part of the game should not be eclipsed by the electronic world provided as a complement inside the computer. In order to retain the outside functionality, various modifications could be made to the terrain outside that keep the outside aspect of the game fun. For example, an area (such as a mat) where the item comprising the character will heal faster; an area where the item changes colour if you are moving; an area where you can interact with other items in various and fun ways.

In order to interface with the computer, the item will require a port, typically a USB port. The item can also have a charging port which can be the same or different to the computer interface port. The charging can be wireless.

The present invention links physical activity to the augmentation of a virtual character. The physical activity of a player involves an interaction with another player. This is different from other devices which might record personal physical activity, but which do not then link that real world interaction involving physical activity to the augmentation of a virtual character. Furthermore, in embodiments, the virtual character is carried with the user, so that there is a direct connection to the user's physical activity and the characters visual appearance. This can enhance the user's perception that their physical activity is making a difference and having some tangible outcome, which can otherwise be difficult to detect in our slow growing and slow changing human bodies.

Thus, in another aspect there is provided a transportable item that measures the physical activity of a user associated with the item while performing the physical activity, a character associated with the transportable item, wherein the character is a computer graphic displayed by the transportable item, wherein the character is changeable visually according to the amount of physical activity of the user including the time span of the physical activity, the distance travelled and or the amount of movement undertaken by the user.

The description relating to the other aspects of the invention described above applies to this aspect of the invention unless the context makes clear otherwise.

In order to measure the physical activity of the user, the item might have therein various components that can track time, location and orientation. These are components that would be known to the skilled addressee. The physical activity of the user might be as part of a game, in which case the user is a player. The item can be a ball.

### BRIEF DESCRIPTION OF THE FIGURES

Embodiments of the invention will now be described with reference to the accompanying drawings which are not drawn to scale and which are exemplary only and in which:

FIG. 1 is an embodiment showing a mode of play where player A is chasing player B.

FIG. 2 is an embodiment showing an alternative mode of play where player B is chasing player A.

FIG. 3 is an embodiment showing a mode of play where player B has locked on to player A.

FIG. 4 is an embodiment showing a mode of play where player A is in healing mode.

FIG. 5 shows an embodiment of the colours that can be displayed in the various modes of the embodiments of FIGS. 1 to 4.

FIG. 6 shows an embodiment of the sounds that can be emitted in the various modes of the embodiments of FIGS. 1 to 4.

FIG. 7 is a schematic view of an embodiment of a ball.

FIG. 8 is a perspective sketch view of the outside of the ball of FIG. 7.

### DETAILED DESCRIPTION OF EMBODIMENTS OF THE INVENTION

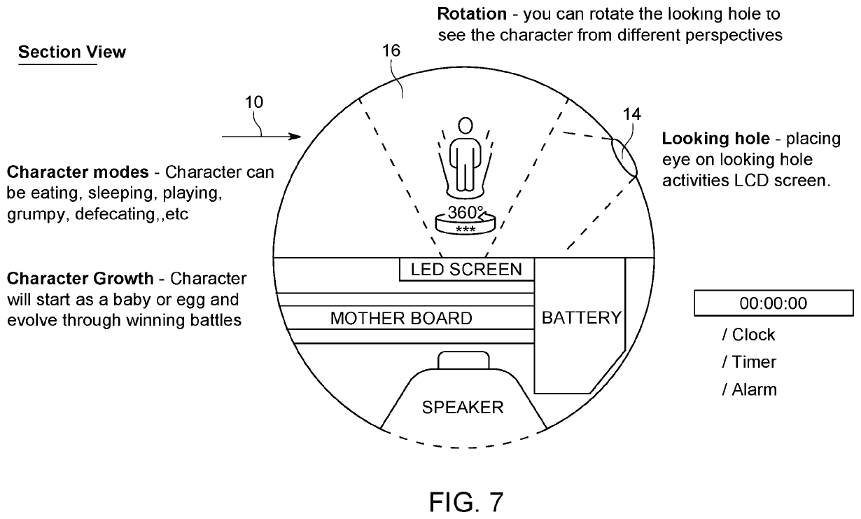

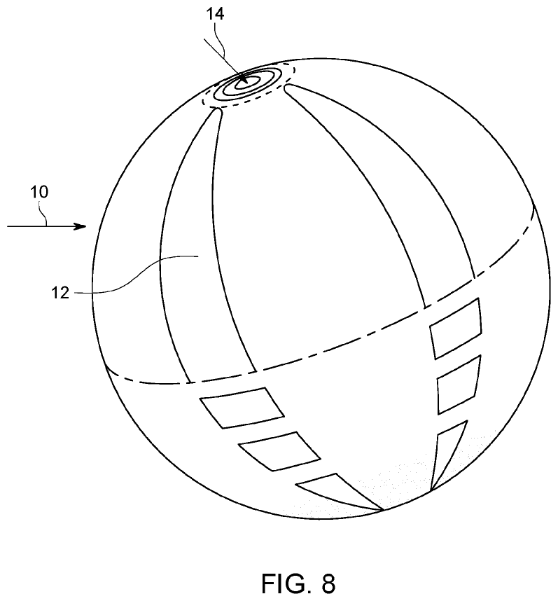

As can be seen in the embodiment of FIG. 8, the item 10 can be a ball 10. The ball can have LED lights 12 on its outer surface. The ball can have a viewing hole into which the player (not shown) can look to the inside of the ball 10. Inside the ball, as shown in FIG. 7, there can be a character 16. The character can be a hologram 16.

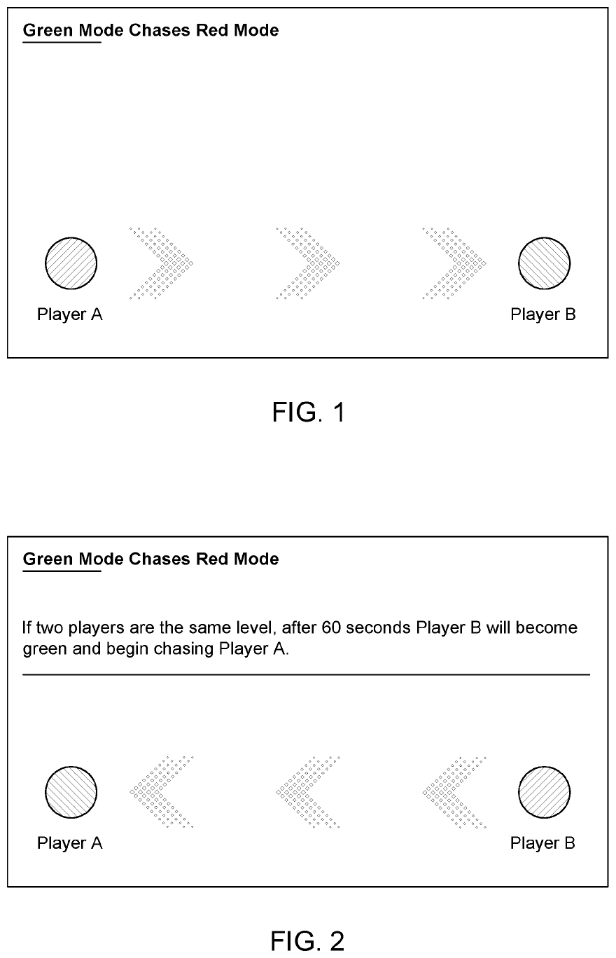

As shown in FIG. 1, a first player A (chaser) can be chased by a second player B (chase). When the first player A is the chaser, the ball is green. When player B is being chased the ball can be red. Player A has about 60 seconds (or more) to catch player B. After about 60 seconds, the roles will switch as shown in FIG. 2 and player A becomes the chased player and player B becomes the chaser.

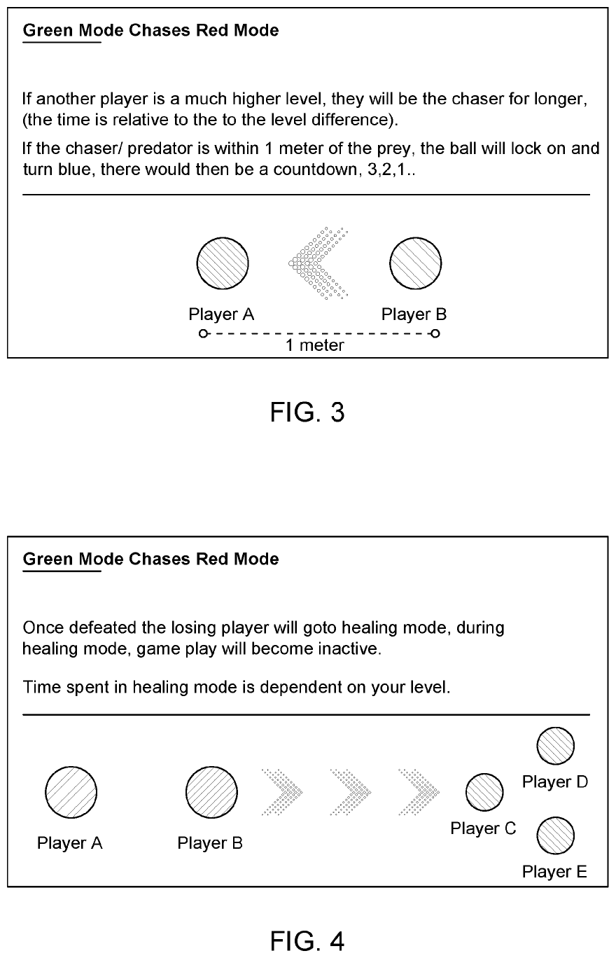

The balls respond to one another as they get closer to one another. FIG. 3 shows that when player B is within 1 meter of player A the ball locks on and turns blue.

Once defeated, the loser of a chasing battle might need heal. This can be seen in FIG. 4 where player A has a ball that has tuned yellow. Player B (still green and still the chaser) is now free to pursue other players C, D and E. But player B must remain alert because after a time period, their ball will change colour and the other players might become the chasers.

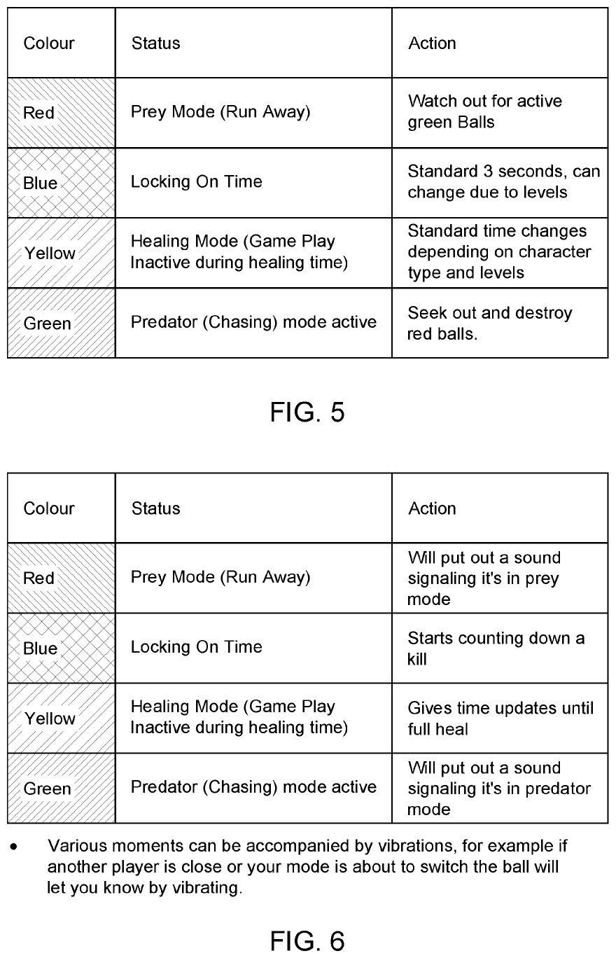

FIGS. 5 and 6 show an embodiment of example light (FIG. 5) and sounds (FIG. 6) that might be associated with each mode of play.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Any promises made in the present description should be understood to relate to some embodiments of the invention and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

It will of course be realised that while the foregoing has been given by way of illustrative example of this invention, all such and other modifications and variations thereto as would be apparent to persons skilled in the art are deemed to fall within the broad scope and ambit of this invention as is herein set forth.

1-12. (canceled)

13. An item intended for use by a player in a multiple player game;
the item configured to pair with and communicate electronically with another item and configured so as to be usable together with that other item in a game with rules, the rules allowing for the scoring of points in the game and or for the assignment of a winner and a loser status to the player having the item in the game;
an electronic character associated with each item, wherein the electronic character is a computer graphic optionally displayed by the item, wherein the electronic character is changeable visually according to points scored in the game and/or the winner status or loser status of the player in the game.

14. The item according to claim 13, wherein the item is a ball.

15. The item according to claim 14, wherein the electronic character is a hologram inside the ball.

16. The item according to claim 15, wherein the character visually increases in strength by increasing in size inside the ball.

17. (canceled)

18. (canceled)

19. The system according to claim 1, wherein the item is configured to sound an alert when another item in accordance with claim 1 comes into close proximity.

20. The system according to claim 1, wherein the item comprises one or more of coloured LEDs, a speaker for generating sound and a vibrator for generating vibrations.

21. The system according to claim 1, wherein the electronic character is a computer graphic displayed by the item,

22. The system according to claim 10, wherein the electronic character is displayed inside the item.
